(19) United States
(12) Patent Application Publication
(10) Pub. No.: US 2010/0033805 A1
(43) Pub. Date: Feb. 11, 2010

(54) ELECTRONIC PAPER DISPLAY DEVICE AND MANUFACTURING METHOD THEREOF

(75) Inventors: Hwan-Soo Lee, Seoul (KR); Yongsoo Oh, Seongnam-si (KR); Sang-Moon Lee, Seoul (KR); Jeong-Bok Kwak, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/539,127

(22) Filed: Aug. 11, 2009

(30) Foreign Application Priority Data
Aug. 11, 2008 (KR) 10-2008-0078627
Mar. 17, 2009 (KR) 10-2009-0022690
Apr. 10, 2009 (KR) 10-2009-0031204
Jun. 17, 2009 (KR) 10-2009-0054000

(51) Int. Cl. G02F 1/167; H01J 9/20

(52) U.S. Cl. 359/296; 445/24

(57) ABSTRACT

An electronic paper display device and a method of manufacturing the electronic paper display device are disclosed. The method in accordance with an embodiment of the present invention includes forming a plurality of partition walls on a lower board, in which the partition walls partition the lower board into cells, disposing a display unit in the cell, and attaching an upper board on an upper part of the plurality of partition walls such that the display unit is covered. This method can adjust a distance between display units and the shape of the display units, and the quantity of disposed display units can be made uniform, whereby the visual quality of the display can be improved by removing spots formed on a screen.

### CROSS-REFERENCE TO RELATED APPLICATIONS

This application claims the benefit of Korean Patent Application Nos. 10-2008-0078627, filed with the Korean Intellectual Property Office on Aug. 11, 2008, 10-2009-0022690, filed with the Korean Intellectual Property Office on Mar. 17, 2009, 10-2009-0031204, filed with the Korean Intellectual Property Office on Apr. 10, 2009, and 10-2009-0054000, filed with the Korean Intellectual Property Office on Jun. 17, 2009, the disclosure of which is incorporated herein by reference in their entirety.

### BACKGROUND

1. Technical Field

The present invention relates to an electronic paper display device and a method of manufacturing the electronic paper display device.

2. Description of the Related Art

Great changes are required today in ways of transmitting and sharing information, in correspondence with a new paradigm that is required in the information society. To meet this, the development of flexible electronic paper, which is also called e-paper, has been accelerated and has entered an initial stage of commercial development.

E-paper is much cheaper in production cost than the conventional flat panel display. Since e-paper does not use a backlight to illuminate its pixels, and does not need to be recharged constantly, it can have superior energy efficiency, while running at very low energy. Moreover, e-paper is very clear, has wider viewing angles, and is capable of holding text and images indefinitely without electricity.

Due to such advantages described above, e-paper may indeed have a variety of applications and have an enormous market potential. Applications may include e-books that have a paper-like surface and are capable of displaying digital versions of books, e-paper magazines with moving illustrations, self-updating newspapers, reusable paper displays for mobile phones, disposable TV screens and electronic wallpapers.

E-paper can be realized through several different methods, including an LCD, an organic EL, a reflective film display, electrophoresis, a twist ball, an electro-chromic method and a mechanically reflective display. In the twist ball and electrophoresis methods, display units are interposed between an upper board and a lower board. Here, uniform placement of the display units is an important factor in determining the quality of displayed images. Accordingly, a number of studies are underway to develop a technology for disposing the display units uniformly and easily.

### SUMMARY

The present invention provides an electronic paper display device and a method of manufacturing the electronic paper display device that can adjust a distance between display units and the shape of the display units and arrange the display units on a plane without using a binder.

An aspect of the present invention provides a method of manufacturing an electronic paper display device. The method in accordance with an embodiment of the present invention includes forming a plurality of partition walls on a lower board, in which the partition walls partition the lower board into cells, disposing a display unit in the cell, and attaching an upper board on an upper part of the plurality of partition walls such that the display unit is covered.

The display unit can be a capsule including a positively-charged (+) particle and a negatively-charged (−) particle dispersed in a fluid. Here, the height of the partition walls can be smaller than the height of the capsule. Also, one of the (+) particle and (−) particle can be a black particle made from carbon black and the other of the (+) particle and (−) particle can be a white particle made from titanium oxide.

The display unit can be two or more kinds of capsules including a charged color particle dispersed in a fluid. The disposing of the display unit in the cell can be performed by closing a portion of the cell and opening another portion of the cell and then injecting the capsule into the opened cell. Also, the disposing of the display unit in the cell can be performed by placing a filter with a number of pores on the lower board and then injecting the capsule into the cell through the pores of the filter.

Moreover, the disposing of the display unit in the cell can be performed by opening a cell in which a capsule having a same color is to be disposed and closing another cell and then injecting one kind of capsules having a same color into the opened cell. Here, the cell, in which the one kind of capsules having the same color is injected, is closed, and a cell, in which another kind of capsules having a different color is to be disposed, is opened, and then another kind of capsules having a different color can be injected into the opened cell.

The display unit can be a rotating body having optical and electrical anisotropy.

The forming of the plurality of partition walls can include stacking a resin layer on the lower board, preparing a stamp having relievo and intaglio patterns formed therein, and pressing the stamp on the resin layer.

The height of a partition wall formed at an outermost end of the lower board can be greater than the height of an adjacent partition wall.

The partition walls can be made of a material selected from a group consisting of polycarbonates (PC), polyethylene terephthalate (PET), polyethersulfone (PES), polyimide, an epoxy system, a urethane system and a polyester system.

The disposing of the display unit can include piling a plurality of display units randomly on the lower board and vibrating the lower board.

The disposing of the display unit can include disposing a filter having pores on an upper portion of the lower board, in which the filter corresponds to the cell, and injecting a capsule into the cell through the filter.

The method can also include removing an overfilled display unit from the cell, performed between the disposing of the display unit and the attaching of the upper board.

The method can also include coating a resin on an upper portion of the display unit, performed between the disposing of the display unit and the attaching of the upper board.

Another aspect of the present invention provides an electronic paper display device. The electronic paper display device in accordance with an embodiment of the present invention include a lower board, in which one surface of the lower board has a plurality of partition walls and the partition walls partition the lower board into cells, a display unit, which is disposed in the cell, and an upper board, which is stacked on an upper portion of the plurality of partition walls so as to cover the display unit.

The height of a partition wall formed at an outermost end of the lower board can be greater than the height of an adjacent partition wall.

The display unit can be a capsule including a positively-charged (+) particle and a negatively-charged (−) particle dispersed in a fluid. Here, one of the (+) particle and (−) particle can be a black particle made from carbon black and the other of the (+) particle and (−) particle can be a white particle made from titanium oxide.

The display unit can be two or more kinds of capsules having a fluid, in which a charged color particle is dispersed. Here, the capsule can be three kinds of capsules representing red, green and blue, respectively, and the capsule can be two kinds of capsules representing complementary colors.

The capsule can include a black particle having different charged properties from the charged color particle, and can have a circular shape, an oval shape or a cylindrical shape.

The display unit can be a rotating body having optical and electrical anisotropy.

The partition walls can be made of a material selected from a group consisting of polycarbonates (PC), polyethylene terephthalate (PET), polyethersulfone (PES), polyimide, an epoxy system, a urethane system and a polyester system.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flow chart illustrating a method of manufacturing an electronic paper display device in accordance with an embodiment of the present invention.

FIGS. 2 to 17 are flow diagrams illustrating a method of manufacturing an electronic paper display device in accordance with an embodiment of the present invention.

FIG. 18 is a perspective view illustrating a display unit in a spherical shape.

FIG. 19 is a perspective view illustrating a display unit in a cylindrical shape.

FIG. 20 is a cross-sectional view illustrating an electronic paper display device in which spherical shaped display units are arranged.

FIG. 21 is a cross-sectional view illustrating an electronic paper display device in accordance with another embodiment of the present invention.

FIGS. 22 to 27 are flow diagrams illustrating a method of manufacturing an electronic paper display device in accordance with another embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

An electronic paper display device and a method of manufacturing the electronic paper display device according to certain embodiments of the present invention will be described below in more detail with reference to the accompanying drawings. Those components that are the same or are in correspondence are rendered the same reference numeral regardless of the figure number, and redundant descriptions are omitted.

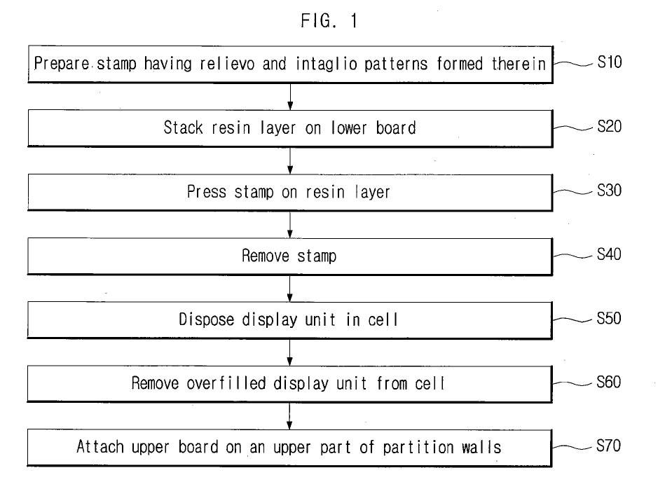

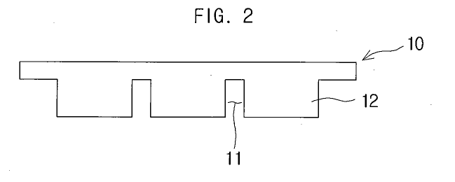

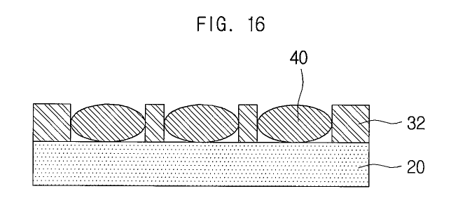

FIG. 1 is a flow chart illustrating a method of manufacturing an electronic paper display device in accordance with an embodiment of the present invention, and FIGS. 2 to 17 are flow diagrams illustrating a method of manufacturing an electronic paper display device in accordance with an embodiment of the present invention. Illustrated in FIGS. 2 to 14 are a stamp 10, intaglio patterns 11, relievo patterns 12, a lower board 20, a resin layer 30, cells 31, partition walls 32, capsules 40, a dam 50, a filter 60 and an upper board 70.

First of all, a method of manufacturing partition walls 32 will be described with reference to FIGS. 2 to 5. First, as illustrated in FIG. 2, a stamp 10 having intaglio patterns 11 and relievo patterns 12 formed therein is prepared (S10). Here, the stamp 10 having the intaglio patterns 11 and the relievo patterns 12 formed therein may be coated with a self-assembled monolayer (SAM). By forming a coating layer (not illustrated) on the relievo patterns 12 by coating the self-assembled monolayer (SAM), the stamp 10 and the resin layer 30 can be easily separated from each other after the stamp 10 having the intaglio patterns 11 and the relievo patterns 12 formed therein and the resin layer 30 are pressed against each other.

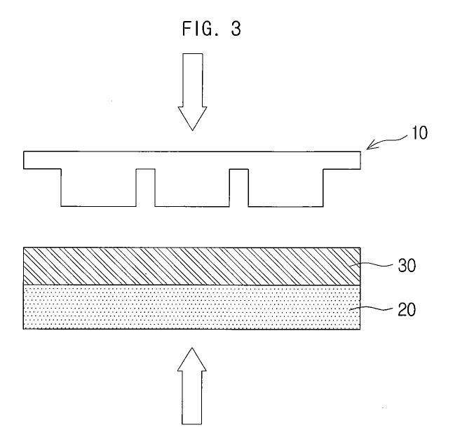

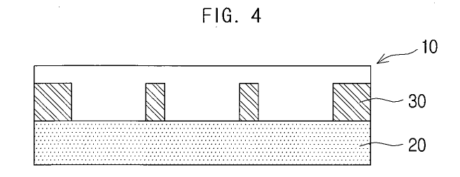

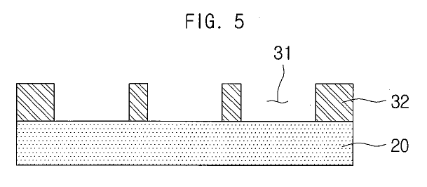

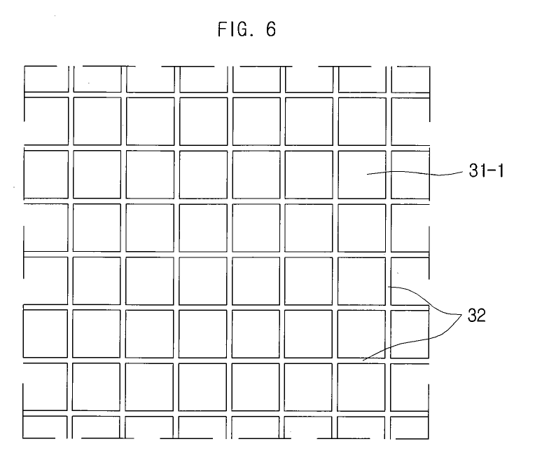

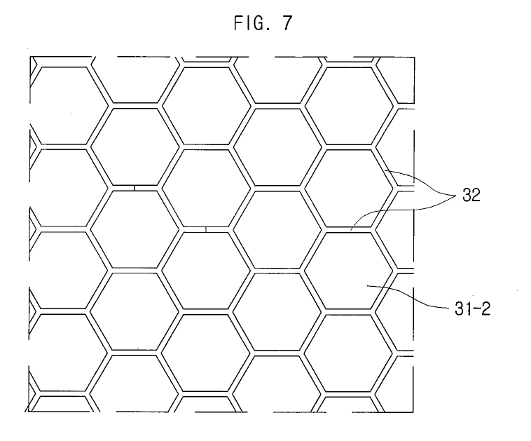

After that, the resin layer 30 is stacked on a lower board 20 (S20, refer to FIG. 3). Then, the stamp 10 is pressed against the resin layer 30 (S30, refer to FIG. 4), so that the partition walls 32 dividing a plurality of cells 31 from one another on the lower board 20 can be formed by removing the stamp 10 (S40, refer to FIGS. 5 and 6). FIG. 5 is a cross-sectional view of the lower board 20 having the partition walls 32 formed therein, and FIG. 6 is a plan view of the lower board 20 having the partition walls 32 formed therein. While FIG. 6 shows cells 31-1 of which a cross section has a rectangular shape, it is possible to form hexagonal-shaped cells 31-2, as illustrated in FIG. 7.

Meanwhile, a thermosetting epoxy material can be used as the resin layer 30. In this case, an imprinting process can be divided into two-step processes such that the partition walls 32 can be formed more efficiently.

For example, the stamp 10 and the resin layer 30 can be thermo-pressed for 30 minutes within a range of temperatures in which the viscosity of the resin layer 30 is the lowest, for example, about 100° C., and then while maintaining the stamp 10 and the resin layer 30 compressed together, the resin layer 30 can be hardened by increasing the temperature up to a temperature range in which the resin layer 30 can be hardened, for example, about 180° C. After these processes, the stamp 10 and the resin layer 30 can be separated from each other.

When using this method described above, the relievo patterns 12 formed in the stamp 10 can be copied on the resin layer 30 more efficiently. Upon or after removing the stamp 10 from the resin layer 30, the shape of patterns copied on the resin layer 30 can be maintained efficiently.

As described above, by manufacturing the partition walls 32 through the imprinting method, the cells 31, 31-1 and 31-2 can be adjusted in various shapes and sizes. Moreover, in the case where capsules 40 are injected into the cells 31, the shape of the capsules 40 can be modified in accordance with the inner shape of the cells 31 over time. As a result, the shape of the capsules 40 can be adjusted.

While this embodiment presents the imprinting method using the stamp 10 for forming the partition walls 32 dividing the cells 31 from one another, it shall be apparent that the present invention is not limited to this method, and there can be other various methods, for example, a dry type or wet type etching method, to form the relievo patterns 32.

The lower board 20 and an upper board 70, which will be described later, are constituted by electrodes, which are formed by coating a transparent electrode, for example, indium-tin-oxide (ITO) or conductive polymer, on a transparent board, for example, glass or plastic. Thus, when voltages are supplied to the electrodes formed on the transparent board, charged particles can be easily attracted.

The partition walls 32 can be made from a flexible material using a polycarbonates (PC) film, a polyethylene terephthalate (PET) film, a polyethersulfone (PES) film or a polyimide film. Moreover, the partition walls 32 can be made from a material selected from the group consisting of an epoxy system, a urethane system and a polyester system.

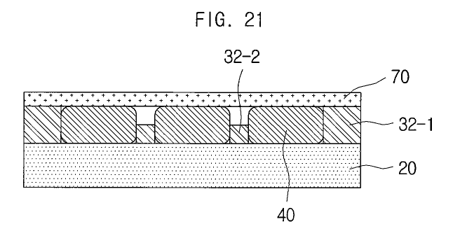

Furthermore, the heights of partition walls (32-2 in FIG. 21) formed at an outermost end of the lower board can be greater than the heights of adjacent partition walls (32-2 in FIG. 21).

Next, a plurality of display units can be disposed in spaces, i.e., the cells 31, that are divided by the partition walls 32 (S50). The display units, which are used for displaying black, white or other colors, are disposed in the cells 31 that are divided by the relievo patterns 32. In this embodiment, the capsules 40 are presented as the display units.

Each of the capsules 40 contains ink particles of a particular color that have a positive (+) or negative (−) charge, ink particles of a different color that have the opposite charge, and a transparent dielectric fluid. That is, the capsule 40 can include at least one kind of particles dispersed in a fluid.

For example, if the (+) charged particles are black particles formed from carbon black, the (−) charged particles can be white particles formed from titanium oxide. Conversely, if the (+) charged particles are white particles formed from titanium oxide, the (−) charged particles can be black particles formed from carbon black.

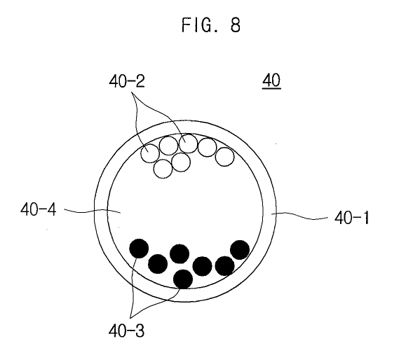

Furthermore, as illustrated in FIG. 8, in the capsule 40, a dielectric fluid 40-4, in which charged color particles 40-2 being moved by the effects of electrophoresis are dispersed, can be sealed by a capsule outer wall 40-1. Black particles 40-3 having different charge properties from the charged color particles 40-2 can be also dispersed in the dielectric fluid 40-4. Here, “color” means any color with chroma or saturation, excluding black and white.

The capsule 40 can be implemented with a color, depending on the color particles 40-2 inside the capsule 40. Here, each of the color particles 40-2 can be in the color of red, green or blue, by which the color of the capsule is determined.

When voltages are supplied to the capsule by way of the electrodes included in the lower board and the upper board, the charged color particles 40-2 can be ascended or descended, so that a color can be displayed while the colors of the ascended color particles 40-2 are reflected.

The method of disposing capsules in the cells 31 that are divided by the partition walls 32 will be described in more detail below.

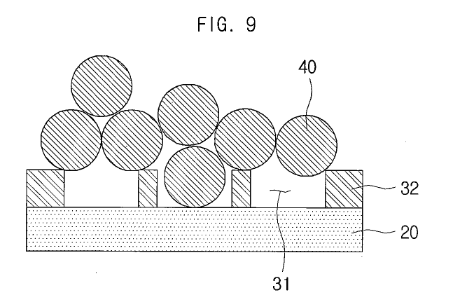

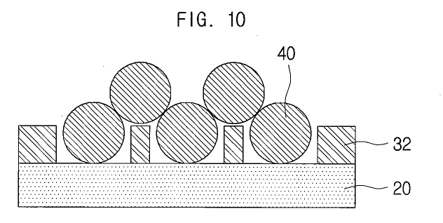

First, as illustrated in FIG. 9, a plurality of capsules 40 are piled on the lower board 40. Here, piling means stacking the plurality of capsules 40 randomly on the lower board 40 without any sorting arrangement. After that, vibrations are introduced to the lower board 20 in such a way that the lower board 20 can be moved from the front, back, left, right, top or bottom to its opposite direction, so that the capsules 40 are injected into the cells, as illustrated in FIG. 10.

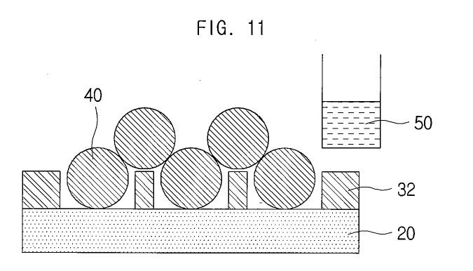

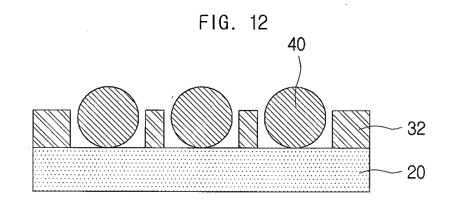

In case two or more layers of capsules 40 are piled on the lower board 20 in spite of the above process, as illustrated in FIG. 10, a dam 50 having a height as tall as that of one single layer of capsules 40 can be used to remove the overfilled capsules by passing the dam 50 over the capsules 40, as illustrated in FIG. 11. Thus, as illustrated in FIG. 12, the capsules 40 can be arranged in a single layer (S60).

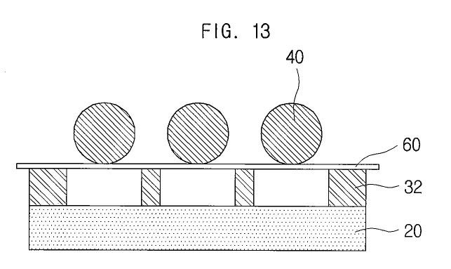

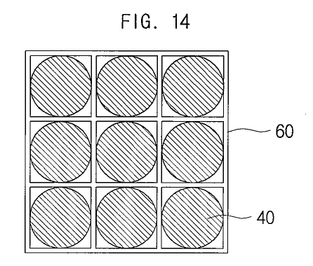

In addition to the above method, a filter 60 can be disposed on top of the lower board 20 having the partition walls 32 formed therein, and then the capsules 40 can be passed through the filter 60, as illustrated in FIG. 13. As illustrated in FIG. 14, if a matched filter 60, of which pores match the spaces formed between the partition walls 32, is used, each of the capsules 40 passing through the filter 60 can be injected into each of the cells 31, respectively.

Although one capsule 40 is disposed into one cell 31 that is divided by the partition walls 32 in the above-described example, it shall be apparent that the present invention is not limited to this example, and a plurality of capsules can be disposed in one cell 31. Nevertheless, it is preferred that the quantity of disposed capsules 40 in each cell 31 is made uniform.

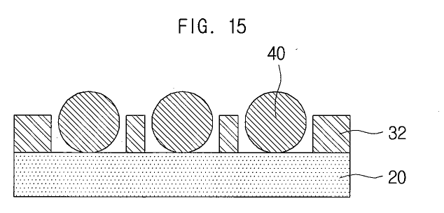

By using the methods described above, the capsules 40 are injected into the cells 31 formed between the partition walls 32, as illustrated in FIG. 15. Here, as illustrated in FIG. 15, if the heights of the capsules 40 are greater than the heights of the partition walls 32, the capsules 40 are protruded over the partition walls 32. Since the capsules 40 contain fluid liquid, for example, oil, the capsules 40 can be pressed down within the cells 31 formed between the partition walls 32 over time, and such form can be maintained after the upper board 70 is stacked later on top of the partition walls 32 and the capsules 40.

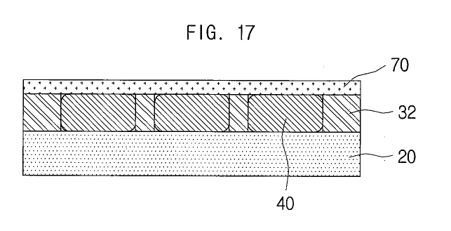

Next, as illustrated in FIG. 17, the upper board 70 is attached on top of the partition walls 32 and the capsules 40 in such a way that the cells 31 are filled with the capsules 40 (S70). Here, a resin can be coated on an upper portion of the capsules, so that a film form can be implemented.

According to the method of manufacturing an electronic paper display in accordance with the present embodiment as set forth above, the partition walls 32 dividing the cells 31, into which the display units are injected, can be formed through the imprinting method. As a result, the space between the cells 31 can be pre-determined, the distance between the display units can be adjusted, and the quantity of disposed display units can be made uniform. Moreover, since the display units, i.e., the capsules 40, are not disposed on top of the partition walls 32, the partition walls 32 can be prevented from contamination.

The material of the partition walls 32 is not limited to a particular material, as long as the material is flexible. In one example, an acryl system, an epoxy system, a urethane system or a polyester system can be used for the partition walls 32. In a more specific example, polycarbonates (PC), polyethylene terephthalate (PET), polyethersulfone (PES) or polyimide can be used for the partition walls 32.

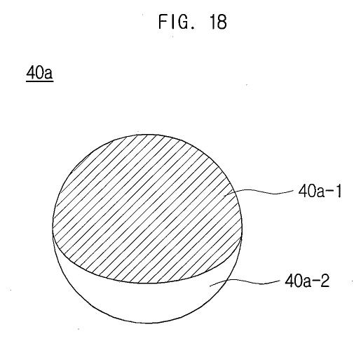

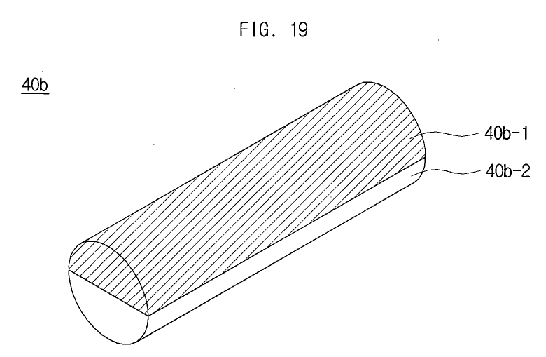

While the various embodiments described above have presented the capsules 40, i.e., the display units, including ink particles of a particular color that have a (+) or (−) charge, ink particles of a different color that have the opposite charge, and a transparent dielectric fluid, it shall be apparent that the present invention is not limited to the above description, and it shall be apparent that the present invention can encompass, for example, rotating bodies 40a and 40b having optical and electrical anisotropy as the display units, as illustrated in FIGS. 18 and 19.

One half of the rotating bodies 40a and 40b being used as the display units can be charged with (+), and the other half of the rotating bodies 40a and 40b can be charged with (−). Also, the rotating bodies 40a and 40b can be mixed with a material displaying black, white or other colors in such a way that the color of the rotating bodies 40a and 40b can be changed with a rotation. Such rotating bodies are rotated by the polarity of the electric field exerted from outside, and thus an image with black and white or other colors can be displayed. Moreover, a fluid can be coated on the surface of the rotating bodies such that the rotating bodies can be rotated more easily.

Illustrated in FIG. 18 is a spherical-shaped rotating body (i.e., a twist ball 40a), of which an upper portion 40a-1 has a black color and a lower portion 40a-2 has a white color. Illustrated in FIG. 19 is a cylinder-shaped rotating body 40b, of which an upper portion 40b-1 has a black color and a lower portion 40b-2 has a white color. In addition to the above, the upper portions 40a-1 and 40b-1 can be colored with red, green or blue, by which the color of the rotating bodies is determined. However, the shape of the rotating bodies is not limited to the examples illustrated herein, and any shape can be possible as long as the color of the rotating bodies can be changed with the rotation.

In the rotating body having two display portions, i.e., the upper portion and the lower portion, each of the two display portions can be formed by electrically and optically processing the display portion through the use of various methods known in the field of art to which the present invention belongs. For example, a rotating body can be introduced to a rotating disk having two coloring liquids, and then a centrifugal force can be applied to the rotating body.

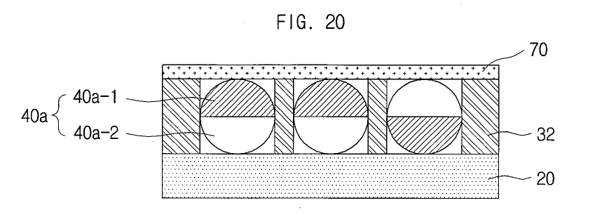

FIG. 20 is a cross-sectional view illustrating an electric paper display device in which the spherical-shaped display units 40a are disposed. If the spherical-shaped rotating body 40a, or the cylinder-shaped rotating body 40b, is used as the display unit, the height of the partition walls 32 may need to be equal to or greater than the height of the display units 40a and 40b, considering that the display units may not be deformed smoothly.

Meanwhile, as illustrated in FIG. 21, the heights of the partition walls 32-1 formed at an outermost end of the lower board 20 can be formed greater than the heights of the partition walls 32-2 adjacent to the partition walls 32-1. In this case, an electronic paper display device with a larger space can be implemented by attaching the partition walls 32-1 positioned at an outermost end and the upper board 70 together.

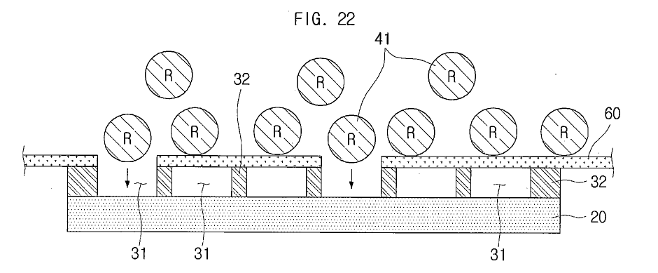

FIGS. 22 to 26 are flow diagrams illustrating a method of manufacturing an electronic paper display device in accordance with another embodiment of the present invention. Compared to the previously described embodiment of the present invention, the present embodiment has a different structure in which two or more kinds of capsules 41, 42 and 43 including charged color particles sealed in a fluid are dispersed into the cells formed on the lower board. More specifically, an electronic paper display device according to the present embodiment includes three kinds of capsules 41, 42 and 43, and the three types of capsules 41, 42 and 43 represent red (R), green (G) and blue (B) colors, respectively. However, the electronic paper display device according to the present embodiment is not limited to the above description, and can include two kinds of capsules, which represent complementary different colors, respectively.

For example, a method of injecting three kinds of capsules, which represent red, green and blue colors, will be described below by referring to FIGS. 22 to 26.

First, as illustrated in FIG. 22, a filter 60 is disposed on the lower board 20 having a plurality of partition walls 32 formed therein. Here, the filter 60 can be disposed such that opened pores of the filter 60 are aligned with cells, on which red capsules 41 are piled. Then, the capsules 41 representing red color are plied on the filter 60. Here, piling means stacking a plurality of capsules in a randomly disordered pile, as described in the drawing. After that, the capsules 41 are injected into the cells through the pores of the filter 60 by applying vibrations to the lower board 20 from the front, back, left or right to its opposite direction. Referring to the drawing, since the diameters of the capsules 41 are greater than the heights of the partition walls 32, the capsules 41 are protruded over the partition walls 32. However, the present invention is not limited to the above description.

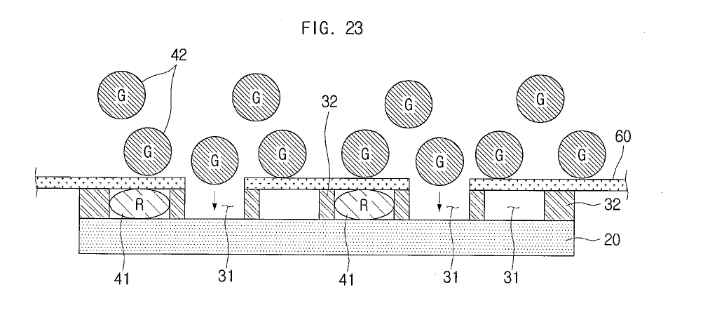

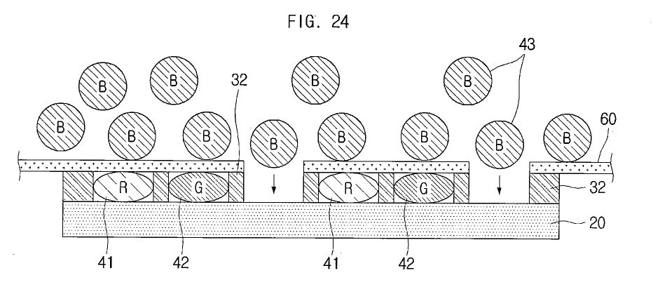

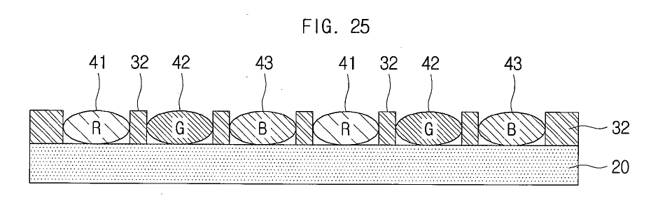

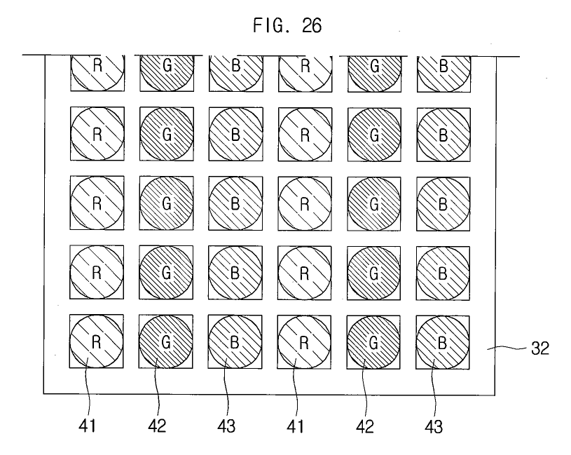

Next, as illustrated in FIG. 23, the filter 60 is disposed on the lower board 20 such that pores of the filter 60 are aligned with cells, on which green capsules 42 are piled. After piling the capsules 42 representing green color on the filter 60 as set forth above, the green capsules 42 can be injected into the cells by applying vibrations to the lower board 20 from the front, back, left or right to its opposite direction. After the green capsules 42 are pressed down over time, the filter 60 can be disposed on the lower board 20 such that pores of the filter 60 are aligned with cells, into which blue capsules 43 are injected, as illustrated in FIG. 24, and then the capsules 43 representing blue color can be injected into the cells through the same method. After the filter 60 is removed, the blue capsules 43 are pressed down with the cell formed between the partition walls over time. FIG. 25 is a cross sectional view of the lower board 20, in which the red, green and blue capsules 41, 42 and 43 are disposed in the cells, respectively, after the filter 60 is removed. FIG. 26 is a plan view of the lower board 20, in which the red, green and blue capsules 41, 42 and 43 are disposed in the cells, respectively, after the filter 60 is removed.

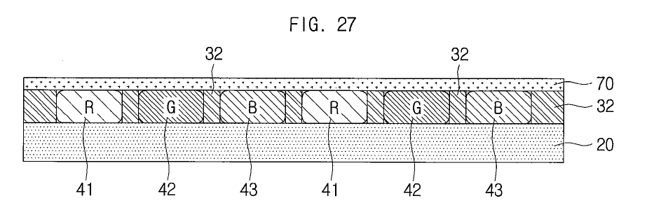

Next, by attaching an upper board 70 on top of the cells and the capsules 41, 42 and 43 in such a way that the upper board 70 faces the lower board 20, an electronic paper display device is fabricated, as illustrated in FIG. 27.

According to the present embodiment, one pixel is constituted by three cells having the capsules 41, 42 and 43 disposed therein. As described above, the three kinds of capsules 41, 42 and 43 contain color particles of red (R), green (G) and blue (B) colors, respectively. When red, green and blue lights are reflected and mixed together, a particular color of light is displayed.

That is, if all the color particles of red, green and blue colors are drifted, white color can be expressed by the additive color mixing. If the color particles of red or green colors are drifted, red or green color can be expressed, respectively. If all the black particles inside the capsule are drifted, black color can be expressed. Moreover, various colors can be expressed, depending on the size of voltage supplied.

The type of display units, each of which represents a different color, is not limited to a particular type. The type of the display units, each of which represents a different color, can be determined in accordance with the color to be implemented. Although it is not illustrated, one pixel can be constituted by three cells having three kinds of display units disposed therein, where the three kinds of display units represent cyan, magenta and yellow, respectively.

Furthermore, the number of cells required to form one pixel is not limited to the above description. For example, one pixel can be constituted by two cells having two kinds of display units, which represent complementary colors, disposed therein.

Various known color particles, for example, pigments, polymers, laked pigments and minerals, in the field of art to which the present invention belongs can be used for the color particles of the present embodiment. Moreover, it is preferred that black particles formed from carbon black are used even though the present invention is not limited to this embodiment.

The shape of capsules 40 is not limited to a particular form. However, the capsules 40 can have, for example, a circular shape, an oval shape or a cylindrical shape.

Since the capsule 40 is pressed down over time, caused by the fluid formed inside the capsules 40, it is preferred that the width of the cell is a little bit greater than the diameter of the capsule 40.

Furthermore, it is preferred that the heights of the partition walls formed at an outermost end are greater than the heights of adjacent partition walls, and the heights of the partition walls located on an inner side of the lower board are smaller than the diameters of the capsules 40. Thus, an electronic paper display device with a larger space can be implemented by attaching the partition walls formed at an outermost end and the upper board together.

In the case where the capsule 40 is not pressed down after the capsule 40 is injected into a cell, it is preferred that the height of the partition wall 30 is greater than the diameter of the capsule 40.

According to the present embodiment, one pixel is constituted by three cells having the capsules 41, 42 and 43 disposed therein, and the three kinds of capsules 41, 42 and 43 contain color particles of red (R), green (G) and blue (B) colors, respectively, so as to display one color. However, the number of cells required to form one pixel is not limited to the above description. For example, one pixel can be constituted by two cells, which represent complementary colors.

While the spirit of the invention has been described in detail with reference to particular embodiments, the embodiments are for illustrative purposes only and shall not limit the invention. It is to be appreciated that those skilled in the art can change or modify the embodiments without departing from the scope and spirit of the invention.

What is claimed is:

1. A method of manufacturing an electronic paper display device, the method comprising:
forming a plurality of partition walls on a lower board, the partition walls configured to partition the lower board into cells;
disposing a display unit in the cell; and
attaching an upper board on an upper part of the plurality of partition walls such that the display unit is covered.

2. The method of claim 1, wherein the display unit is a capsule comprising a positively-charged (+) particle and a negatively-charged (−) particle dispersed in a fluid.

3. The method of claim 2, wherein a height of the partition walls is smaller than a height of the capsule.

4. The method of claim 2, wherein one of the (+) particle and (−) particle is a black particle made from carbon black and the other of the (+) particle and (−) particle is a white particle made from titanium oxide.

5. The method of claim 2, wherein the display unit is two or more kinds of capsules having a fluid sealed therein, a charged color particle being dispersed in the fluid.

6. The method of claim 5, wherein the disposing of the display unit in the cell is performed by closing a portion of the cell and opening another portion of the cell and then injecting the capsule into the opened cell.

7. The method of claim 5, wherein the disposing of the display unit in the cell is performed by placing a filter with a number of pores on the lower board and then injecting the capsule into the cell through the pores of the filter.

8. The method of claim 5, wherein the disposing of the display unit in the cell is performed by opening a cell in which a capsule having a same color is to be disposed and closing another cell and then injecting one kind of capsules having a same color into the opened cell.

9. The method of claim 8, wherein the cell in which the one kind of capsules having the same color is injected is closed, and a cell in which another kind of capsules having a different color is to be disposed is opened, and then another kind of capsules having a different color is injected into the opened cell.

10. The method of claim 1, wherein the display unit is a rotating body having optical and electrical anisotropy.

11. The method of claim 1, wherein the forming of the plurality of partition walls comprises:
stacking a resin layer on the lower board;
preparing a stamp having relievo and intaglio patterns formed therein; and
pressing the stamp on the resin layer.

12. The method of claim 1, wherein a height of a partition wall formed at an outermost end of the lower board is greater than a height of an adjacent partition wall.

13. The method of claim 1, wherein the partition walls are made of a material selected from a group consisting of polycarbonates (PC), polyethylene terephthalate (PET), polyethersulfone (PES), polyimide, an epoxy system, a urethane system and a polyester system.

14. The method of claim 1, wherein the disposing of the display unit comprises:
piling a plurality of display units randomly on the lower board; and
vibrating the lower board.

15. The method of claim 1, wherein the disposing of the display unit comprises:
disposing a filter having pores on an upper portion of the lower board, the filter corresponding to the cell; and
injecting a capsule into the cell through the filter.

16. The method of claim 1, further comprising removing an overfilled display unit from the cell, performed between the disposing of the display unit and the attaching of the upper board.

17. The method of claim 1, further comprising coating a resin on an upper portion of the display unit, performed between the disposing of the display unit and the attaching of the upper board.

18. An electronic paper display device comprising:
a lower board, one surface of the lower board having a plurality of partition walls, the partition walls partitioning the lower board into cells;
a display unit being disposed in the cell; and
an upper board being stacked on an upper portion of the plurality of partition walls so as to cover the display unit.

19. The electronic paper display device of claim 18, wherein a height of a partition wall formed at an outermost end of the lower board is greater than a height of an adjacent partition wall.

20. The electronic paper display device of claim 18, wherein the display unit is a capsule comprising a positively-charged (+) particle and a negatively-charged (−) particle dispersed in a fluid.

21. The electronic paper display device of claim 20, wherein one of the (+) particle and (−) particle is a black particle made from carbon black and the other of the (+) particle and (−) particle is a white particle made from titanium oxide.

22. The electronic paper display device of claim 18, wherein the display unit is two or more kinds of display units representing a different color, respectively.

23. The electronic paper display device of claim 22, wherein the capsule is three kinds of capsules representing red, green and blue, respectively.

24. The electronic paper display device of claim 22, wherein the display unit is three kinds of display units representing cyan, magenta and yellow, respectively.

25. The electronic paper display device of claim 22, wherein the capsule is two kinds of capsules representing complementary colors.

26. The electronic paper display device of claim 22, wherein the capsule comprises a black particle having different charged properties from the charged color particle.

27. The electronic paper display device of claim 18, wherein the display unit has a circular shape, an oval shape or a cylindrical shape.

28. The electronic paper display device of claim 18, wherein the display unit is a micro capsule having a fluid sealed therein, a charged color particle being dispersed in the fluid.

29. The electronic paper display device of claim 18, wherein the display unit is
rotating body having optical and electrical anisotropy.

30. The electronic paper display device of claim 29, wherein the rotating body comprises:
a first display portion being colored red, green or blue; and
a second display portion being colored white.

31. The electronic paper display device of claim 18, wherein the partition walls are made of a material selected from a group consisting of polycarbonates (PC), polyethylene terephthalate (PET), polyethersulfone (PES), polyimide, an epoxy system, a urethane system and a polyester system.
